(19) United States
(12) Patent Application Publication
(10) Pub. No.: US 2012/0198507 A1
(43) Pub. Date: Aug. 2, 2012

(54) Multichannel Video Player System

(76) Inventors: Reinold Geiling, Frechen (DE); Alain Gilles Bertoni, Cologne (DE); Maurice Kenneth Carroll, Carrigaline (IE); Terry Lowe, Las Vegas, NV (US)

(21) Appl. No.: 13/018,415

(22) Filed: Jan. 31, 2011

(51) Int. Cl. H04N 5/93; H04N 7/173; H04N 5/935

(52) U.S. Cl. 725/109; 386/353; 386/219; 386/E05.002; 386/E05.003

(57) ABSTRACT

An example multichannel video player includes a digital processor, random access memory coupled to the digital processor, a plurality of video outputs coupled to the digital processor and non-volatile memory coupled to the digital processor. The non-volatile memory includes program instructions which are transferrable to the random access memory and are executable on the digital processor. The non-volatile memory also includes a plurality of multichannel video tracks. An example method for providing a multichannel video system includes storing on a server a plurality of video tracks, where each video track includes a plurality of synchronized video segments, transferring at least one video track from the server to a player computer over the Internet and storing the at least one video track in non-volatile memory of the player computer.

### BACKGROUND

There are many public and private venues where audio/visual performances can be used to enhance mood or provide entertainment. While such audio/visual performances can be live performances, such performances tend to be expensive, limited in duration, and of uneven quality. Recorded audio/visual performances can be more convenient, cost effective and of more consistent quality, but are often not very engaging due to the limitations of audio/visual displays.

For example, a high-definition video display can be used to display mood-setting scenery or a musical performance. In some instances, multiple video displays including video projectors, LED walls, etc. can also be used. However, such multiple video display systems tend to be complicated and expensive in that each display requires its own video player. Furthermore, any coordination between the video players requires even more complication and expense. Also, the requirement for multiple players makes it more difficult prevent unauthorized accessed to copyrighted materials used in the performance. Still further, the lack of resolution of traditional video displays, even with high definition video displays, detracts from recorded performances.

Examples of systems which can be used to control multiple displays with multiple players include Pandora's Box of Coolux (Germany), Watchout or Dataton (Sweden), DVS Servers of Digital Video Systems (Germany) and Hippotizer of Green Hippo (England). As noted above, these systems tend to be complex and expensive and, therefore, arc generally limited to large events having big audio/visual budgets.

There has been some development of personal-computer based systems for displaying video on multiple screens. For example, U.S. Pat. No. 7,667,707 of Margulis is describes a computer system for supporting multiple remote displays. As another example, U.S. Pat. No. 7,627,808 describes a computer media synchronization player. However, neither of these patents teach a player system adapted for compelling audio/visual performances for mood setting or entertainment.

As noted above, one of the limiting factors in the enjoyment of traditional entertainment systems is the quality of the digital display. Even current high definition displays such as 720 p and 1080 p displays have insufficient resolution in larger formats to provide compelling imagery. An emerging standard known as “4K” includes approximately 4,000 pixels of horizontal resolution by doubling both the horizontal and vertical resolution of a 1080 p display. However, 4K displays require even more expensive players, making the use of multiple 4K displays prohibitively expensive in many cases.

These and other limitations of the prior art will become apparent to those of skill in the art upon a reading of the following descriptions and a study of the several figures of the drawing.

### SUMMARY

A multichannel video player, set forth by way of example and not limitation, includes a digital processor, random access memory coupled to the digital processor, a plurality of video outputs coupled to the digital processor and non-volatile memory coupled to the digital processor. By way of further non-limiting example, the non-volatile memory includes program instructions which are transferrable to the random access memory and are executable on the digital processor. By way of still further non-limiting example, the non-volatile memory also includes a plurality of multichannel video tracks.

A multichannel video system, set forth by way of example and not limitation, includes a player computer configured to play a multichannel video track including a plurality of synchronized video outputs and a server including a plurality of multichannel video tracks. By way of further non-limiting example, the server is in at least part time contact with the player computer and is configured to deliver at least one multichannel video track the player computer via the Internet.

A method for providing a multichannel video system, set forth by way of example and not limitation, includes storing on a server a plurality of video tracks, where each video track includes a plurality of synchronized video segments, transferring at least one video track from the server to a player computer over the Internet and storing the at least one video track in non-volatile memory of the player computer.

An advantage of example embodiments is that a single computer can be used as a player for a multichannel video display system providing lower cost and better security for multichannel tracks. Furthermore, a single computer makes it more practical to provide 4K display devices in a multichannel video system by using multiple output graphic cards. This facilitates rendering multiple screens from a single computer process and which also helps synchronize the multiple displays.

An advantage of further example embodiments is that a server may be used to deliver multichannel video tracks to a video player over the Internet and to handle accounting matters for the performance site.

These and other apparatus, systems and methods herein will become apparent to those of skill in the art upon a reading of the following descriptions and a study of the several figures of the drawing.

### BRIEF DESCRIPTION OF THE DRAWINGS

Several example embodiments will now be described with reference to the drawings, wherein like components are provided with like reference numerals. The example embodiments are intended to illustrate, but not to limit, the invention. The drawings include the following figures:

FIG. 1 is an illustration of an example multichannel video system;

FIG. 2 is a block diagram of an example video player of FIG. 1;

FIGS. 3-5 are example screen shots generated by example program instructions running on the multichannel video player of FIG. 2;

FIG. 6 is a flow diagram of example programs instructions running on the multichannel video player of FIG. 2;

FIG. 7 is a flow diagram of the PLAY TRACK operations of FIG. 6;

FIG. 8 is a flow diagram of the DOWNLOAD operation of FIG. 6; and

FIG. 9 is a flow diagram of example program instructions running on a video server of FIG. 1.

### DETAILED DESCRIPTIONS

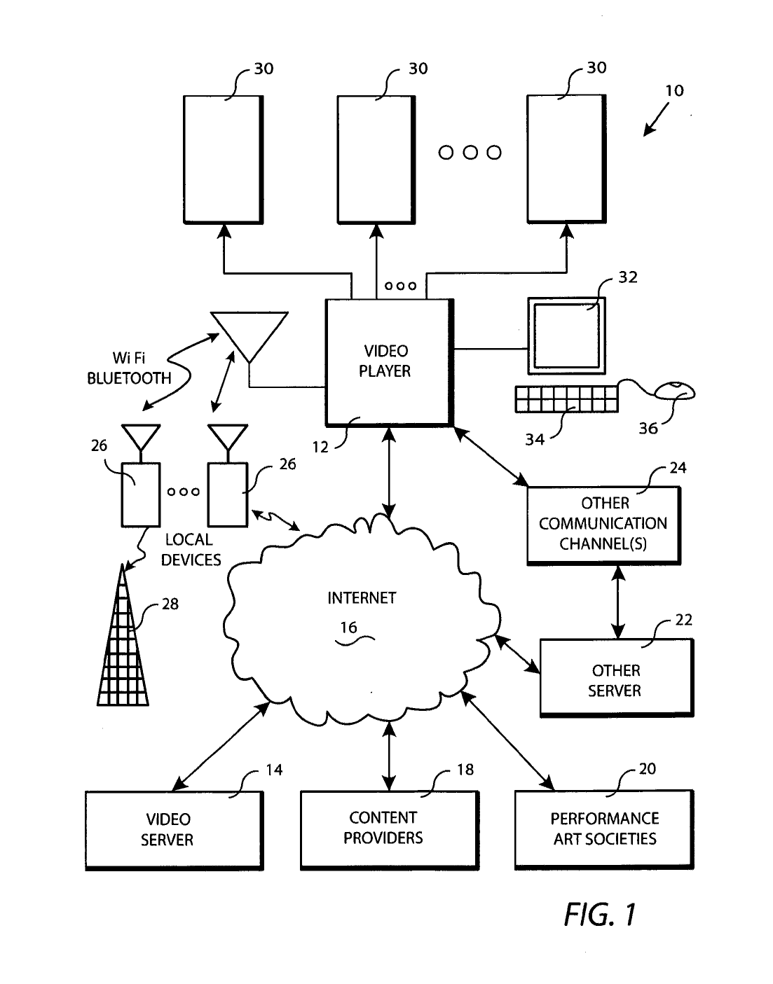

In FIG. 1, a multichannel video system 10, set forth by way of example and not limitation, includes a video player 12 and a video server 14. In this example, the video player 12 and video server 14 communicate via a wide area network (WAN) such as the Internet 16. The multichannel video system 10 can further include, for example, other servers coupled to the Internet 16 such as a content provider server 18, a performance art society server 20 and/or other server 22. By way of further non-limiting example, the other server 22 may communicate with video player 12 by other communication channel(s) 24 in addition to or instead of communicating via the Internet 16. For example, such other communication channel(s) 24 may include a satellite communication channel, the public telephone system, local area networks, etc.

The multichannel video system 10 may further include local devices 26 which can communicate with video player 12 and/or another communication channel 28. By way of non-limiting examples, the local devices 28 can be “smart” telephones such as an iPhone® telephone, an Android® telephone, a Blackberry® telephone, etc. and the another communication channel 28 can be a cellular tower which permits access to the public telephone system and to the Internet. The local devices, in this example, can communicate with video player 12 wirelessly by, for example, Bluetooth or WiFi. Other communication channels may also be suitable (e.g. IR, acoustical, etc.)

In the example system of FIG. 1, video player 12 is coupled to a number of visual displays 30. By way of non-limiting examples, the visual displays 30 can be 4K displays. Alternatively, the visual displays can be other forms of display including projection displays, 1080 p displays, LED displays, etc. Also, in the example of FIG. 1, an optional monitor 32, keyboard 34 and mouse 36 to provide local interaction with the video player 12. As an alternative, non-limiting example, a local device 26 such as a smart phone, tablet computer, laptop computer, etc. can be used to interact with the video player 12.

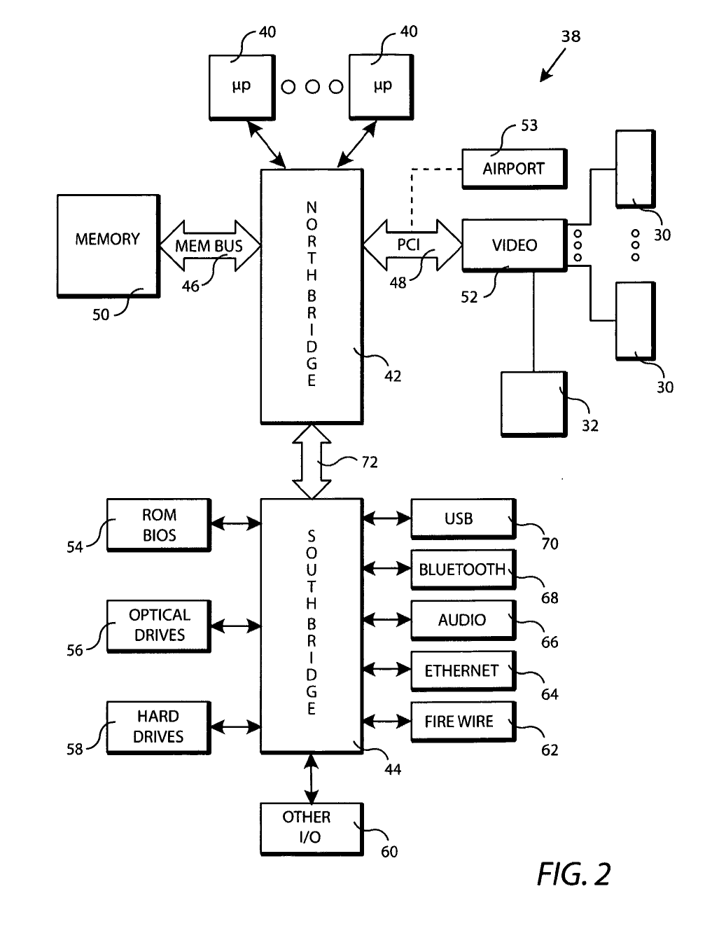

FIG. 2 is a block diagram, set forth by way of example and not limitation, of a multichannel video player 38. By way of non-limiting example, the multichannel video player 38 may include a computer or workstation such as a Mac Pro® from Apple; Inc. As will be appreciated by those of skill in the art, the multichannel video player 28 may be constructed from other computer platforms.

In the example of FIG. 2, the multichannel-video player 28 may include one or more microprocessors 40 and an associated chipset which, in this non-limiting example, includes a Northbridge 42 and a Southbridge 44. In this example, the Northbridge 42 includes a memory bus controller 46 and PCI bus 48 bridge. Random access memory 50, such as DRAM and SRAM is coupled by the memory bus 46 to the Northbridge 42. Also, in this example, video card(s) 52 are coupled to Northbridge 42 by PCI bus 48. An optional Airport® 53 can also be supported by the PCI bus 48. Video displays 30 and/or monitor 32 may be connected to the video card(s) 52.

Southbridge 44, in this example, are coupled to other (typically slower) I/O devices such as the ROM BIOS 54, optical drives 56, hard drives 58, “other” I/O 60, Firewire 62, Ethernet 64, audio output(s) 66, Bluetooth 68 and USB ports 70. Northbridge 42 communicates with Southbridge 44 via a bus 72.

As noted above, a suitable platform for multichannel video player 28 is a Mac Pro which features Intel Xeon microprocessors with up to 12 processing cores. A suitable configuration, set forth by way of non-limiting example, includes 8 cores, 2 ATI-5570 graphic cards and an NVIDIA G-Force 120 graphics card. For example, the ATI-5570 graphic cards can provide 6 video channels for displays 30 while the NVIDIA G-Force 120 can provide a 7^{th} video channel for a display 30 and a video channel for monitor 32. The Airport 53 can be used for a connection to Internet 16, as can Ethernet connection 64.

In the present example, the multichannel video player 12 can support multiple operating systems including Mac OS X 10.4.7 and later, Microsoft Windows XP and Vista 32-bit & 64 bit versions, and other 80×86 operating systems such as Linux x86, Solaris, DOS, BeOS and BSD. In this example, Mac OS X may be used.

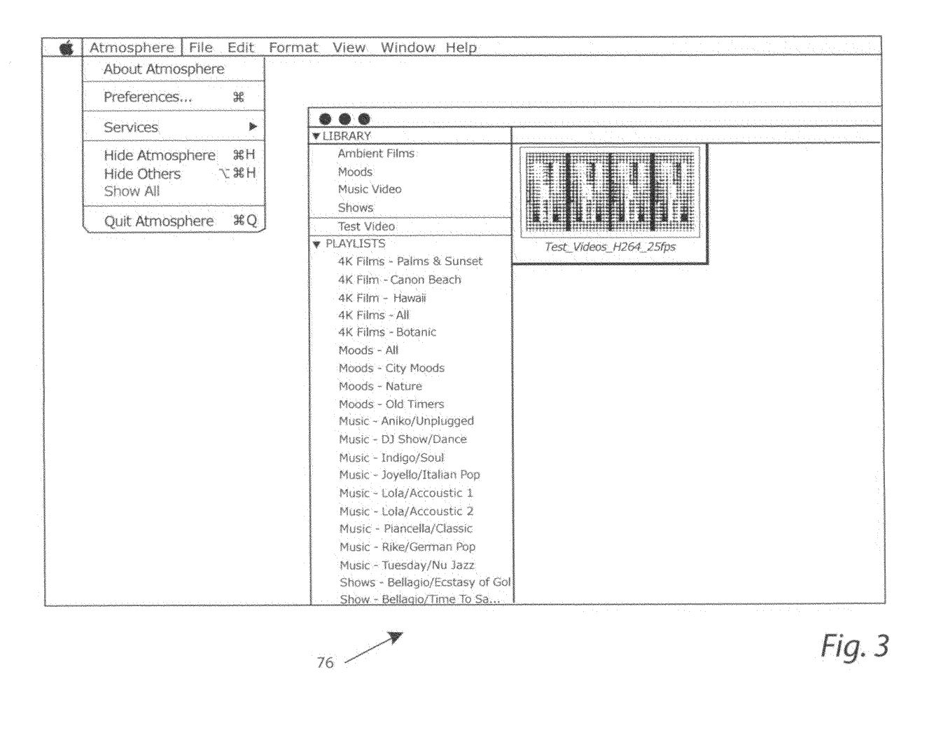

FIGS. 3-5 are depictions of example screen displays which may be displayed on monitor 32 by video player 12. More particularly, program instructions are stored in non-volatile memory, such a hard drive 58, which are transferrable to random access memory 50 for execution on microprocessor(s) 40 can provide the screens of FIGS. 3-5 on monitor 32.

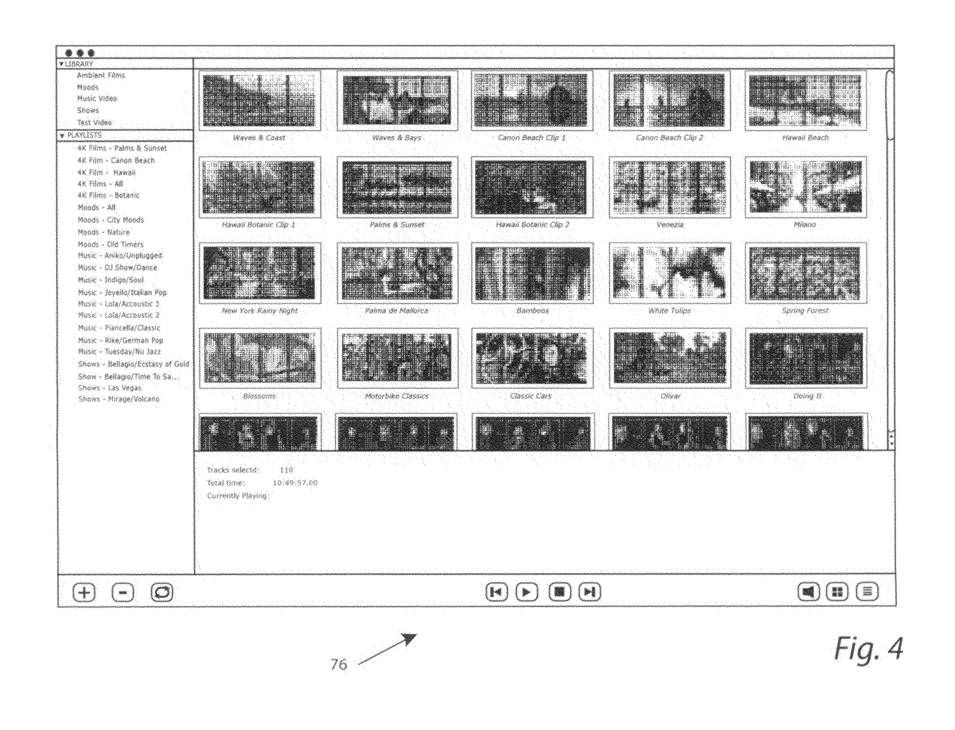

In FIG. 3, a portion of the desktop generated by the Mac OS X operating is illustrated. Running on the video player 12 are program instructions of the program Atmosphere™ which creates a window 76 that allows user interaction with the video player 12. For example, in FIG. 4, various “tracks” are displayed in the main portion of window 76 which may be presented for play. In the selection bar forming the left margin of the window 76 various “library” titles and “playlists” are listed.

As used herein, a “track” is a multi-channel, synchronized video file which may be played by video player 12. Also as used here, “video” may include both audio and video, just video, or just audio content. A track may be stored as separate files on the hard drive 58. A “playlist” comprises two or more tracks which are played in concurrently or in sequence. For example, a music-video track may be played and then a “mood” track may be played. As another example, a video-only track may be played concurrently with an audio-only track. A “library” is a collection of tracks and/or playlists set forth by a theme or category.

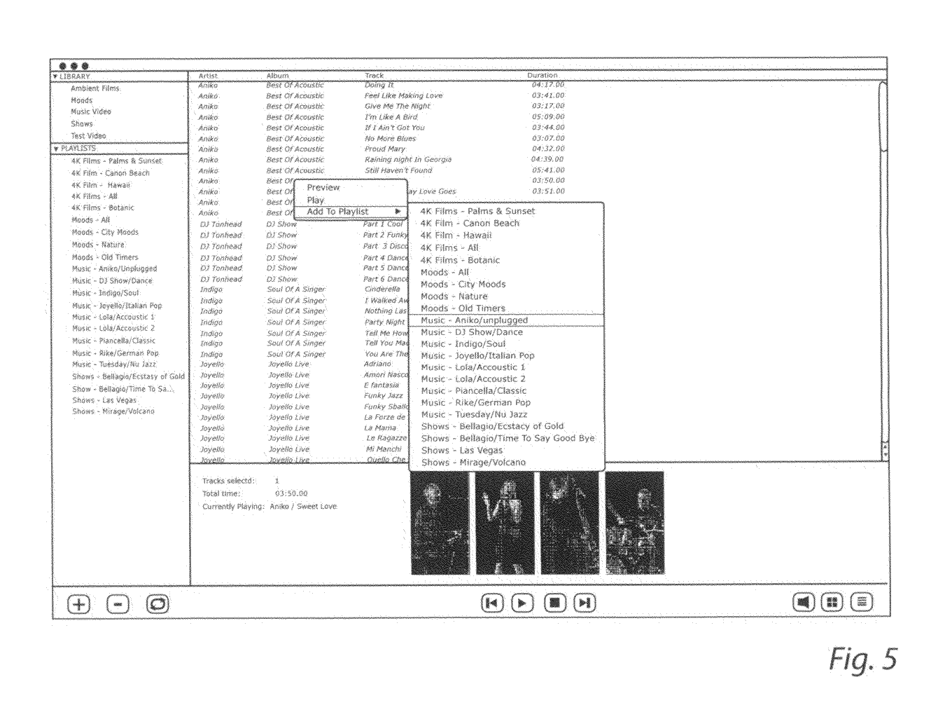

As seen in FIG. 5, the Atmosphere program instructions include the ability to create playlists from tracks. In this particular example, Aniko/Unplugged is being added to a playlist. As will be discussed subsequently, playlists may be started manually or may be programmed to loop, start at a particular time, etc.

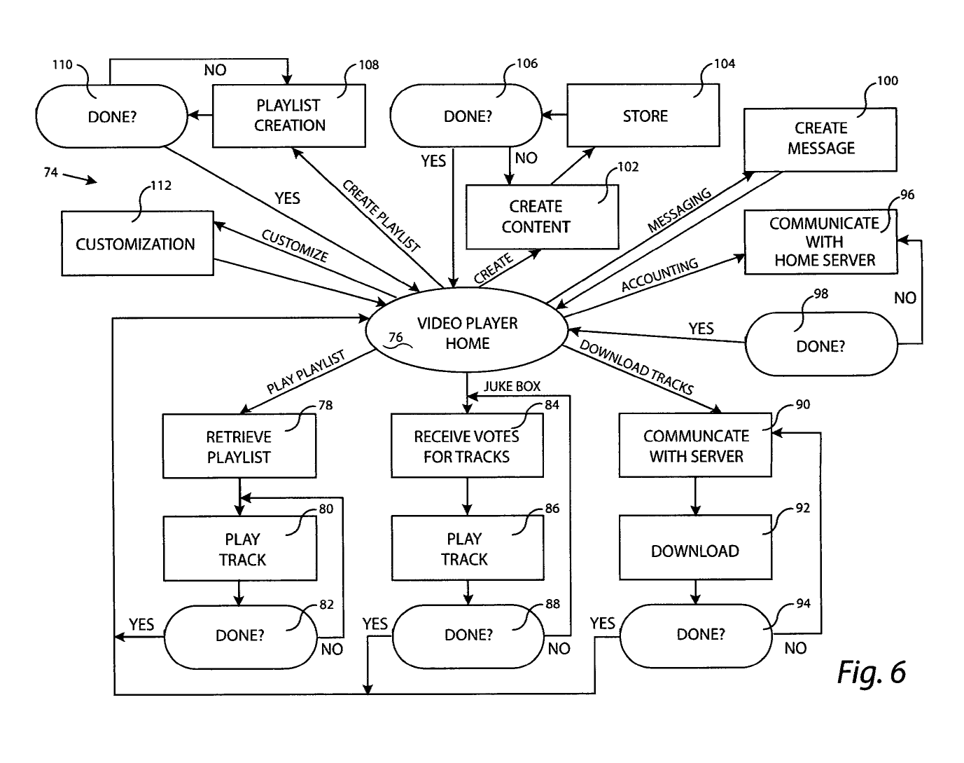

In FIG. 6, a process running on video player 12 is illustrated as a flow diagram, it being understood that this depiction is by way of illustration only. The process 74 idles at 76 and then performs a variety of functions based upon interrupts from, for example, a user, an interval timer, a server communication, etc. For example, the interrupt PLAY PLAYLIST may be generated, for example, manually by a user or in response to a timer, real time clock or script.

The interrupt PLAYLIST includes the operation 78 of retrieving the playlist. For example, the playlist can be retrieved from the hard drive 58. Next, an operation 80 PLAY TRACK plays the next track in the playlist. A decision operation 82 determines if all of the tracks in the playlist have been played and, if so, control is returned to idle operation 76. If the entire playlist has not been played, operation 80 is repeated.

The process JUKEBOX, in this non-limiting example, receives “votes” for track from mobile devices 26. For example, a number of tracks can be displayed on a display 30 an various members of the audience can “vote” with their mobile device 26 for a favorite track. The track which receives the most votes can be played at operation 86. If the “juke box” session is over as determined by operation 88, control can be returned to the idle operation 76. Otherwise, a new track can be vote for at operation 84. As an alternative, instead of allowing voting in operation 84, a user of the player system 12 can specify the next track to he played during the play of the currently played track, thereby acting as a disc jockey (“DJ”). The user can use a local device 26, the keyboard 34, mouse 36, or other I/O devices to make this selection.

The interrupt DOWNLOAD TRACKS initiates communication with a video server, such as video server 14. As will be discussed subsequently, this may be initiated as either a push or a pull. The DOWNLOAD TRACKS interrupt begins with a communication with video server 14 via the Internet 16, in this example. Once the communication connection has been made, operation 92 can be used to download video tracks, playlists, etc. from the video server 14 to the video player 12. A decision operation 94 determines if the download is complete.

An ACCOUNTING operation can, again, be initiated, by way of non-limiting examples, as a push or a pull. For example, the video server 14 may determine that it is time to determine what tracks have been played by video player 12. This accounting information can be accumulated and reported to, for example, performing rights organization such as ASCAP and BMI.

Process 74 further has the ability to provide messaging on one or more of the displays 30. For example, a message could be generated wishing a patron a Happy Birthday or a message could be generated that drinks will be ½ price for the next 30 minutes. The create message operation 100 can be implemented, by way of non-limiting example, using the keyboard 34 of FIG. 1.

Another process supported by video player 12 can be the ability to create content. This interrupt is typically generated by a user, who creates content in an operation 102 by importing and synchronizing audio and video and then storing the created content as a track on, for example, non-volatile memory such as hard drive 58 in an operation 104. Decision operation 106 determines whether the CREATE process has been completed.

As noted previously with respect to FIG. 5, a user may also create playlists. This is also typically a user-generated interrupt caused, by example, with a pull-down menu selection. The process begins with the playlist creation operation 108 and a decision operation 110 determines if the playlist creation process is complete.

Playlist generation can include the selection and ordering of video tracks as well as selecting segments of video tracks for play. For example, a 10 second segment of a video track starting 15 seconds into the video track can be specified for playback. Furthermore, video tracks can be overlapped with other video and/or audio tracks in this operation 108.

A number of other customization and preferences can also be implemented as indicated by operation 112. For example, graphic overlays and/or transparencies can be displayed on displays 30. By way of further non-limiting examples, a custom frame or a logo can be added as an overlay or transparency over a track being played.

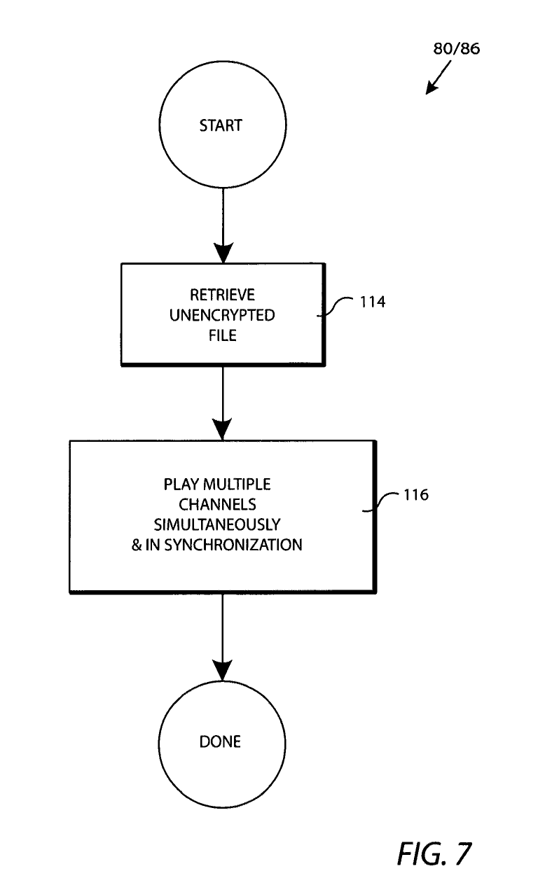

FIG. 7 illustrates the operations 80/86 of FIG. 6 in greater detail. In an embodiment, set forth by way of example and not limitation, video tracks may be stored as encrypted files on a hard drive 58 or other non-volatile memory. For example, channels may be stored as encrypted structures with a standard media wrapper format. Operation 114 then retrieved and decrypts the video track, preferably “on the fly” to provide an unencrypted file for playback, e.g. by being piped through a decryption engine before being passed to a playback codec. Then, in an operation 116, by way of non-limiting example, multiple channels are played simultaneously and in frame-by-frame synchronization on the various displays 30 in an operation 116. As another example, the multiple channels can be synchronized sufficiently to create a unified performance but not necessarily on a frame-by-frame basis. Of course, if the video tracks are not encrypted, the decryption operation is not required.

As noted previously, a multichannel track may be stored as separate files. Playback of a multi-channel track is begun by playing a track for each channel, where one of the tracks is selected as the master timer and notifying the “slave” tracks of the master timer. Master/slave synchronization is well known to those of skill in the art. Playback of the tracks can use standard codecs and playback libraries (e.g. QuickTime®).

Under certain circumstances, synchronization of the video tracks may not need to be frame accurate. In a network-clustered environment, network delays might sporadically interfere with timing signals or where external clocks are used there may be a delay crossing a process boundary on entry to a system which may cause a video frame to either e dropped or repeated to keep the general master/slave clocks “in sync.” Provided that this does not impact the presented experience it may be deemed an acceptable solution.

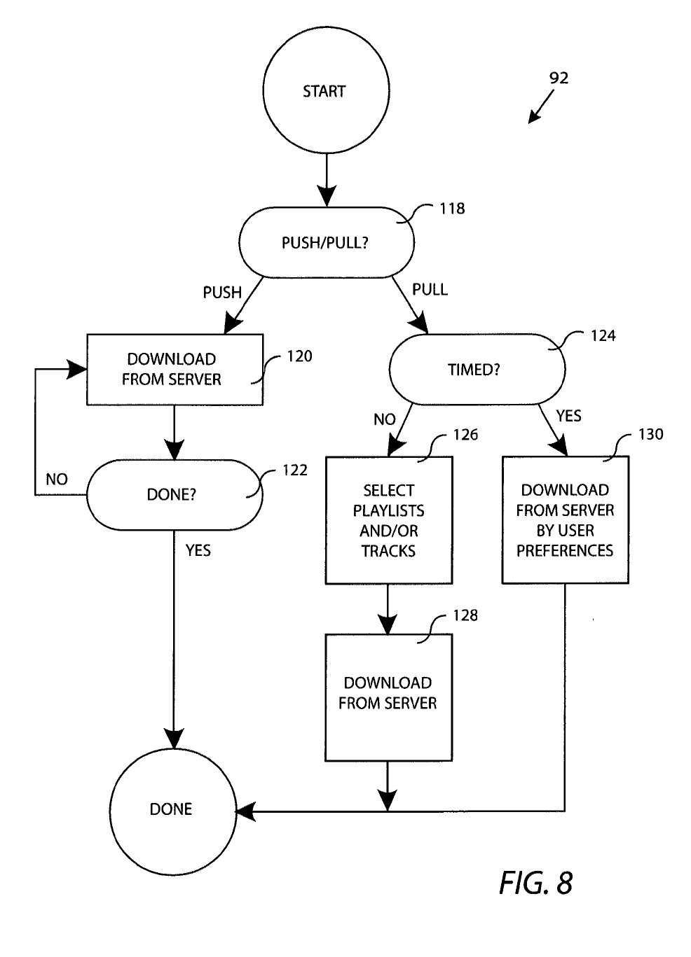

FIG. 8 illustrates the DOWNLOAD operation 92 in greater detail. First, it is determined whether the connection with the server 14 is a PUSH or a PULL. By “PUSH” it is meant that the server 14 initiates the download while by “PULL” it is meant that the player 12 initiates the download.

In the case of a PUSH, operation 120 downloads video tracks, playlists and/or other data from the server 14. An operation determines whether the download is complete. In the case of a PULL, operation 124 determines whether it is timed or a manual download. If it is a manual download, and operation 126 allows a user to select playlists and/or video tracks for download from server 14 in an operation 126 and then to download the selected playlists and/or video tracks in an operation 128. Otherwise, if the PULL is a timed pull based upon some criteria, downloads from the server 14 are made automatically based, by way of non-limiting example, on user preferences. A timed pull can be based upon, a real time clock of the video player 12 which is either built-in or added on to the system, an interval timer, a trigger, an on-line clock etc. Furthermore, timed pull can be based upon a schedule or other criteria.

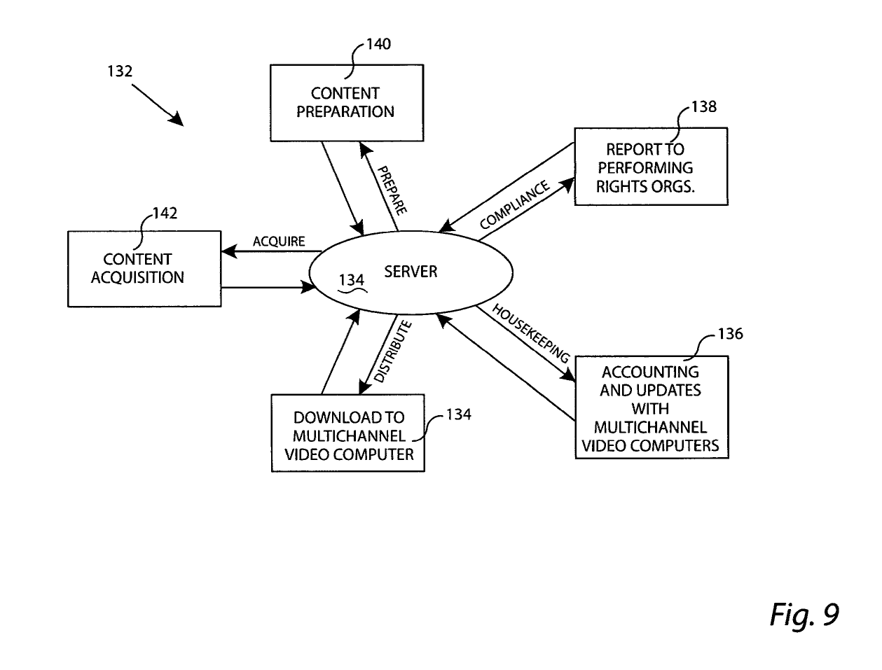

FIG. 9 is a flow diagram of an example process 132 running on video server 14 of FIG. 1. It will be appreciated that server 14 may be a computer or workstation based system which can be of similar design to that shown in FIG. 2, by way of non-limiting example. The process can be implemented by program instructions including code segments for implementing various operations as was the case with respect to the video player 12.

In FIG. 9, process 132 includes a server IDLE state 134. A DISTRIBUTE interrupt causes a DOWNLOAD operation 134. By way of non-limiting examples, the DISTRIBUTE interrupt can be generated as a PUSH or a PULL. In the case of a PUSH, the interrupt may be generated by a scheduler or timer and may include the use of a real-time clock of the video server 14 or an on-line timer or counter.

A HOUSEKEEPING interrupt can be used, for example, accounting purposes. By way of non-limiting examples, an operation 136 can provide updates to a video player 12, obtain accounting information from a player 12, etc. A COMPLIANCE interrupt can be used to report to performing rights organizations such as ASCAP and BMI in an operation 138.

A PREPARE interrupt can be used to prepare video tracks and playlists for distribution in an operation 140. Also, ACQUIRE interrupt can be used to acquire video tracks from third party producers in an operation 142. In either of these two operations, a synchronization process make take place. This can be accomplished in a number of fashions, as is well known to those of skill in the art. For example, in a master/slave implementation a master clock can be set to an audio channel or to the vertical synchronization of one of the video channels (as appropriate for the particular track). By way of non-limiting example, there is a single audio channel and multiple video channels. Playback of the synchronized, multi-channel video track is conveniently accomplished by standard audio/video codecs and playback libraries, e.g. a QuickTime® utility from Apple, Inc.

The several example embodiments described above are for illustrative purposes and are by no means meant to be exhaustive of alternatives. For example, in certain installations the system can be run in a “kiosk mode” for added security. Kiosk mode makes access to the stored tracks and the software of the video player more difficult and helps prevent theft and/or unauthorized tampering.

In another example embodiment, the software of the video player allows the mapping of the screens comprising section of the computer desktop to the video channels. This allows the installation to be moved and the screens reconnected without needing to either physically reconnect the screens to the previous graphic outputs, nor having to remap the desktop (which would not be possible in the aforementioned kiosk mode).

Although various embodiments have been described using specific terms and devices, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of various other embodiments may be interchanged either in whole or in part. It is therefore intended that the claims be interpreted in accordance with the true spirit and scope of the invention without limitation or estoppel.

What is claimed is:

1. A multichannel video player comprising:
a digital processor;
random access memory coupled to the digital processor;
a plurality of video outputs coupled to the digital processor; and
non-volatile memory coupled to the digital processor, the non-volatile memory including program instructions which are transferrable to the random access memory and executable on the digital processor, the non-volatile memory also including a plurality of multichannel video tracks.

2. A multichannel video player as recited in claim 1 wherein the program instructions include code segments for playing a multichannel video track to provide a plurality of video signals at the plurality of video outputs.

3. A multichannel video player as recited in claim 2 wherein the plurality of video signals are synchronous.

4. A multichannel video player as recited in claim 3 wherein the plurality of video signals are synchronized on a frame-by-frame basis.

5. A multichannel video player as recited in claim 4 further comprising a plurality of visual displays coupled to the plurality of video outputs.

6. A multichannel video player as recited in claim 5 further comprising an audio output coupled to the digital processor and wherein the program instructions include code segments for providing an audio signal at the audio output which is synchronous with the plurality of video signals.

7. A multichannel video player as recited in claim 6 wherein the audio output is one of a plurality of audio outputs coupled to the digital processor and wherein the audio signal is one of a plurality of audio signals at the plurality of audio outputs which are synchronous with the plurality of video signals.

8. A multichannel video player as recited in claim 7 further comprising a plurality of audio displays coupled to the plurality of audio outputs.

9. A multichannel video player as recited in claim 8 wherein the multichannel video tracks are stored in the non-volatile memory in an encrypted form.

10. A multichannel video player as recited in claim 9 further comprising at least one playlist stored in the non-volatile memory including a reference to a plurality of the multichannel video tracks, wherein said playlist specifies the timing and duration of play of the plurality of multichannel video tracks.

11. A multichannel video player as recited in claim 10 wherein the program instructions include code segments to play a plurality of multichannel video tracks according to the at least one playlist.

12. A multichannel video player as recited in claim 11 wherein the program instructions include code segments to play of at least one of the multichannel video tracks and the playlist one of before and during a current video track play.

13. A multichannel video player as recited in claim 12 further comprising a dongle coupled to the digital processor to prevent unauthorized access to at least one of the program instructions and the multichannel video tracks.

14. A multichannel video player as recited in claim 13 further comprising at least one of a real-time clock and an interval timer.

15. A multichannel video system comprising:
a player computer configured to play a multichannel video track including a plurality of synchronized video outputs; and
a server including a plurality of multichannel video tracks, the server being in at least part time contact with the player computer and being configured to deliver at least one multichannel video track the player computer via the Internet.

16. A multichannel video system as recited in claim 15 wherein the at least one multichannel video track that is delivered to the player computer in an encrypted format.

17. A multichannel video system as recited in claim 16 wherein the server includes at least one playlist which can be delivered to the player computer via the Internet.

18. A method for providing a multichannel video system comprising:
storing on a server a plurality of video tracks, where each video track includes a plurality of synchronized video segments;
transferring at least one video track from the server to a player computer over the Internet; and
storing the at least one video track in non-volatile memory of the player computer.

19. A method for providing a multichannel video system as recited in claim 18 further comprising storing at least one playlist of video tracks on the server and transferring the at least one playlist of video tracks to the player computer over the Internet.

20. A multichannel video player as recited in claim 19 further comprising playing at least one of the video tracks and the playlist of video tracks.
